(19) United States
(12) Patent Application Publication
(10) Pub. No.: US 2026/0221996 A1
(43) Pub. Date: Jul. 30, 2026

(54) SPATIAL SPECTRUM ANALYZER

(71) Applicant: TELEFONAKTIEBOLAGET LM ERICSSON (PUBL), Stockholm (SE)

(72) Inventors: Magnus Nilsson, Lund (SE); Peter Jakobsson, Lund (SE)

(21) Appl. No.: 19/145,429

(22) PCT Filed: Jan. 10, 2023
(86) PCT No.: PCT/EP2023/050460

§ 371 Date: Jul. 2, 2025

(51) Int. Cl. H04B 1/10; H04B 1/71; H04B 7/08

(52) U.S. Cl. CPC H04B 1/1036; H04B 1/71; H04B 7/086

(57) ABSTRACT

Embodiments of a method performed by network node in a Radio Access Network (RAN) of a wireless communication system are disclosed. In one embodiment, the method comprises determining that a link quality for at least one carrier of a plurality of carriers within a bandwidth of a wideband receiver of the network node is less than a link quality threshold. The method further comprises, for each carrier for which the link quality is less than the threshold, obtaining complex data samples of a received narrowband signal received via a narrowband receiver of the network node that is tuned to a portion of the frequency band used by the wideband receiver that comprises the carrier and determining directions from which interference is to be mitigated based on the complex data samples. The method further comprises receiving a wideband signal using a beam pattern which comprises nulls at the determined directions.

### TECHNICAL FIELD

The present disclosure relates to interference mitigation in a wireless communication system.

### BACKGROUND

Wireless communication system bitrate demand continues to increase. Low frequency spectrum fills up and higher frequency spectrum is taken into use. In the 3^{rd} Generation Partnership Project (3GPP) 5^{th} Generation (5G) System (5GS), a new frequency range is introduced, namely, Frequency Range 2 (FR2), which spans the frequency range of 24,250 Megahertz (MHz) to 52,600 MHz. In the 5GS, beamforming is introduced both to increase capacity and coverage. In FR2, initially, beamforming is mainly used to combat the higher pathloss due to the use of higher frequencies. Beamforming and beamsteering are performed by coherently combining radio frequency (RF) signals from multiple antenna elements. By applying the appropriate phase-shifts and gains to the signals provided to, or received from, the antenna elements, the desired transmit or receive beam is formed. This technology contributes to a mitigation of the above listed problems by means of a radically increased beam gain, which restore the rated Equivalent Isotropic Radiated Power (EIRP) rating for downlink and Effective Isotropic Sensitivity (ESI) for uplink of millimeter wave (mmW) base stations to usable levels.

Beamforming can be performed in many ways. The basic beamforming techniques are briefly reviewed below.

A popular, low-complexity way of performing beamforming is analog beamforming. For analog beamforming, the signals to/from the antennas are beamformed in the RF domain, close to the antenna. The rest of the signal chain is common to all or a portion of the antenna elements. For transmit beamforming, what happens then is that all the data is converted into a time domain stream early, before being sent to the radio Application Specific Integrated Circuits (ASICs) and antennas. Since one set of beam weights is applied during the duration of one Orthogonal Frequency Division Multiplexing (OFDM) symbol, the transmit beam is therefore spatially fixed for all data. Although it may have peaks in multiple directions, the data stream will be transmitted through one beam pattern, which obviously limits the possibility to simultaneously transmit data to multiple users. Put otherwise, this generates problems when it would be advantageous to direct different data streams in different beam directions, by frequency selective scheduling. In addition, problems are created when the User Equipment (UE) is trying to find the base station for initial access. Present FR2 Advanced Antenna Systems (AASs) use beam sweeping or wider initial beams to combat these issues, but this adds cost in terms of coverage, latency, and/or capacity.

Another beamforming technique is digital beamforming. Digital beamforming uses late Inverse Fast Fourier Transform (IFFT) processing to transform complex Orthogonal Frequency Division Multiple Access (OFDMA) symbols to data streams in time, with each user accessing all antenna elements independently, thereby allowing frequency selective beam forming. This allows for Multi-User Multiple Input Multiple Output (MU-MIMO), where the users can be multiplexed, both spatially and in frequency domain. This does however require IFFT processing per antenna and is computationally expensive. It also implies extreme interface bitrates. Thus, digital beamforming is especially cumbersome when the number of antenna elements grows very larger (e.g., approaches 1,000 or more antenna elements or more) and with very large channel bandwidths (e.g., channel bandwidths exceeding 1 Gigahertz (GHz)).

Distributed digital beamforming is a beamforming technique that may be used to combat the issue of high bitrates when using digital beamforming with a large number of antennas while retaining the advantages of Frequency Division Multiplexing (FDM) and Spatial Division Multiplexing (SDM). However, when using distributed beamforming, digital processing has no access to each antenna and, therefore, beam sweeping is required in the uplink for UE directional finding.

To mitigate the problems with distributed digital beamforming, a parallel narrowband receiver may be used to extract data for a small frequency portion of the total bandwidth from each antenna element and send this extracted data to the digital processing unit for digital processing. The narrowband signals received in this manner are sufficient for estimation of the main direction(s) of the received signal(s). Since directions are more stable than the complex channel, a second wideband receiver can then, in a second step, use the directions to perform wideband beamformed reception in the directions obtained from the narrowband receiver. This secures wideband reception that retains a high Signal to Noise Ratio (SNR), while reducing the number of data streams that needs to be interfaced for further combining to one data stream for each direction. One example of distributed digital beamforming with a parallel narrowband receiver is described in International Publication Number WO 2021/223892 A1 entitled “Versatile AAS Receiver”, which was filed on May 8, 2020 and published on Nov. 11, 2021.

A recent addition to 3GPP systems is the Integrated Access and Backhaul (IAB) architecture. The IAB architecture promises good cost savings by avoiding the need of fiber or Mini-link connected to each base station. In the IAB architecture, part of the huge capacity offered by the wide bandwidths in FR2 is used for backhaul traffic.

There are several implementations of an IAB network. FIG. 1 depicts a base station centric implementation of an IAB network. In this example, normal downlink slots are reused for IAB traffic. Some downlink capacity is sacrificed for IAB operation. This solution means that no added interference is caused to the radio system by the IAB operation. However, the IAB receiver is sensitive to interference from other base stations that are transmitting on the downlink in the same slots that are used for IAB traffic. As shown in FIG. 1, co-channel and adjacent channel interference from other sectors in a particular base station can be handled by muting the other sectors.

Another similar application is sensing or radar. Joint Communication and Sensing (JCAS) is expected to be an important part of 6^{th} Generation (6G) wireless communication systems. There are different flavors of sensing such as, e.g., monostatic sensing or bi/multi-static sensing. In monostatic sensing, the same base station is receiving and transmitting the radar pulse. In bi/multi-static sensing, one or several base stations transmit the radar pulses whereas other base stations receive the radar pulses. Radar operation is preferably conducted using downlink slots to avoid interference. Similar to IAB operation, radar reception is susceptible to interference from other base stations.

### SUMMARY

Systems and methods are disclosed for mitigating interference at a wideband receiver of a wireless network node. In one embodiment, a method performed by network node in a Radio Access Network (RAN) of a wireless communication system comprises determining that a link quality for at least one carrier of a plurality of carriers within a bandwidth of a wideband receiver of the network node is less than a predefined or configured link quality threshold. The method further comprises, for each carrier of the at least one carrier for which the link quality is less than the predefined or configured link quality threshold, obtaining complex data samples of a received narrowband signal received via a narrowband receiver of the network node that is tuned to a portion of the frequency band used by the wideband receiver that comprises the carrier for which the link quality is less than the predefined or configured link quality threshold and determining, based on the complex data samples of the narrowband signal, one or more directions from which interference is to be mitigated. The method further comprises receiving a wideband signal using a beam pattern which comprises one or more nulls at the directions from which interference is to be mitigated. In this manner, interference is mitigated, which in turn enables, for example, simplified cell planning particularly in a network deployment in which the network node is an Integrated Access and Backhaul (IAB) node.

In one embodiment, a bandwidth for the narrowband receiver is such that the portion of the frequency band used by the wideband receiver for which the complex data samples of the received narrowband signal are obtained comprises the carrier for which the link quality is less than the predefined or configured link quality threshold and one or more adjacent channels.

In one embodiment, the method further comprises, for a beam pattern for which the wideband receiver is able to configured, calculating a set of beamforming parameters that define the beam pattern such that the beam pattern comprises one or more nulls at the directions from which interference is to be mitigated, wherein receiving the wideband signal comprises receiving the wideband signal while the wideband receiver is configured in accordance with the set of beamforming parameters for the beam pattern.

In one embodiment, determining the one or more directions from which interference is to be mitigated comprises calculating, based on the complex data samples obtained via the narrowband receiver, a plurality of received power values for a respective plurality of beam patterns having corresponding primary beam lobes at different beam angles and determining, based on the plurality of received power values, one or more beam patterns from among the plurality of beam patterns for which the received power values are greater than a predefined or configured threshold. The one or more directions from which interference is to be mitigated are directions that correspond to the beam angles of the primary beam lobes of the one or more beam patterns for which the receiver power values are greater than the predefined or configured threshold.

In one embodiment, the at least one carrier for which the link quality is less than the predefined link quality threshold consists of a single carrier.

In one embodiment, the at least one carrier for which the link quality is less than the predefined link quality threshold consists of two or more carriers.

In one embodiment, the network node is an IAB node.

Corresponding embodiments of a network node are also disclosed. In one embodiment, a network node for a RAN of a wireless communication system comprises processing circuitry configured to cause the network node to determine that a link quality for at least one carrier of a plurality of carriers within a bandwidth of a wideband receiver of the network node is less than a predefined or configured link quality threshold. The processing circuitry is further configured to cause the network node to, for each carrier of the at least one carrier for which the link quality is less than the predefined or configured link quality threshold, obtain complex data samples of a received narrowband signal received via a narrowband receiver of the network node that is tuned to a portion of the frequency band used by the wideband receiver that comprises the carrier for which the link quality is less than the predefined or configured link quality threshold and determine, based on the complex data samples of the narrowband signal, one or more directions from which interference is to be mitigated. The processing circuitry is further configured to cause the network node to receive a wideband signal using a beam pattern which comprises one or more nulls at the directions from which interference is to be mitigated.

Embodiments of systems and methods related to mitigating interference during radar scanning are also disclosed. In one embodiment, a method performed by a network node in a RAN of a wireless communication system comprises performing radar scanning over a frequency band using a plurality of beam patterns having corresponding primary beam lobes at different beam angles, other than a subset of the plurality of beam patterns to be excluded from radar scanning, using a wideband transmitter and a wideband receiver of the network node. The method further comprises obtaining complex samples of a narrowband signal received via a narrowband receiver of the network node that is tuned to a portion of the frequency band over which the network node performs the radar scanning, determining, based on the complex samples of the narrowband signal, one or more directions for which interference is to be mitigated, and updating the subset of the plurality of beam patterns to be excluded from radar scanning based on the determined one or more directions for which interference is to be mitigated. In this manner, radar blind spots may be avoided or mitigated, and pollution of communication links of other network nodes (e.g., base stations) due to the radar scanning may be avoided or mitigated.

In one embodiment, determining the one or more directions for which interference is to be mitigated comprises calculating, based on the complex samples of the narrowband signal, a plurality of received power values for the plurality of beam patterns, respectively, wherein the plurality of beam patterns have primary beam lobes at different beam angles, and determining, based on the plurality of received power values, one or more beam patterns having primary beam lobes at beam angles that correspond to the one or more directions for which interference is to be mitigated. In one embodiment, determining, based on the plurality of received power values, the one or more beam patterns having primary beam lobes at beam angles that correspond to the one or more directions for which interference is to be mitigated comprises, for each received power value, comparing the received power value to a respective power threshold, wherein the respective beam pattern is determined to be one of the one or more beam patterns having primary beam lobes at beam angles that correspond to the one or more directions for which interference is to be mitigated if the received power value is greater than the respective power threshold.

In one embodiment, the method further comprises repeating the steps of obtaining, determining, and updating for one or more additional portions of the frequency band over which the network node performs the radar scanning.

In one embodiment, the network node is an IAB node.

Corresponding embodiment of a network node are also disclosed. In one embodiment, a network node for a RAN of a wireless communication system comprises processing circuitry configured to cause the network node to perform radar scanning over a frequency band using a plurality of beam patterns having corresponding primary beam lobes at different beam angles, other than a subset of the plurality of beam patterns to be excluded from radar scanning, using a wideband transmitter and a wideband receiver of the network node. The processing circuitry is further configured to cause the network node to obtain complex samples of a narrowband signal received via a narrowband receiver of the network node that is tuned to a portion of the frequency band over which the network node performs the radar scanning, determine, based on the complex samples of the narrowband signal, one or more directions for which interference is to be mitigated, and update the subset of the plurality of beam patterns to be excluded from radar scanning based on the determined one or more directions for which interference is to be mitigated.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 depicts a base station centric implementation of an Integrated Access and Backhaul (IAB) network;

FIG. 2 shows one common possible scenario in where there is co-channel and/or adjacent channel interference between the backhaul link from one IAB node to a IAB donor node and the backhaul link from another IAB node and an Nth IAB node (denoted as “IAB-N”);

FIG. 3 depicts a typical one-dimensional beam pattern when using a uniform linear array;

FIG. 4 shows the same beam pattern as in FIG. 3 after a null has been placed in the beam pattern in the direction of the interference in accordance with one embodiment of the present disclosure;

FIG. 5 illustrates one example of a wireless communication system in which embodiments of the present disclosure may be implemented;

FIG. 6 shows a one example embodiment of an IAB node;

FIG. 7 shows a generic block diagram of an example embodiment of an analog Radio Frequency (RF) transceiver, which is part of the analog portion of a Radio Frequency Integrated Circuit (RFIC) of the IAB node of FIG. 6;

FIG. 8 shows an example embodiment of a digital portion of an RFIC of the IAB node of FIG. 6;

FIG. 9 is a flow chart that illustrates the operation of a network node to detect the direction(s) of a source(s) of interference and to update beam patterns utilized by a wideband receiver of the network node to include a null(s) in the direction(s) of the source(s) of interference, in accordance with one embodiment of the present disclosure;

FIG. 10 is a flow chart that illustrates the operation of a network node to configure a wideband receiver in accordance with the set of beamforming parameters calculated in the process of FIG. 9 and to receive a signal via the wideband receiver in accordance with an embodiment of the present disclosure;

FIG. 11 illustrates one example of a wireless communication system that is enabled to have a more dense deployment for both cell-to-cell distance for the same operator (left side of FIG. 11) as well as more dense deployment between different operators (right side of FIG. 11) by the IAB nodes operating in accordance with embodiments of the present disclosure to mitigate interference;

FIG. 12 illustrates the operation of a network node to utilize a narrowband receiver to detect the direction(s) of interferer(s), or blocker(s), in association with a radar scanning procedure in accordance with another embodiment of the present disclosure; and

FIGS. 13, 14, and 15 are schematic block diagrams of example embodiments of a network node.

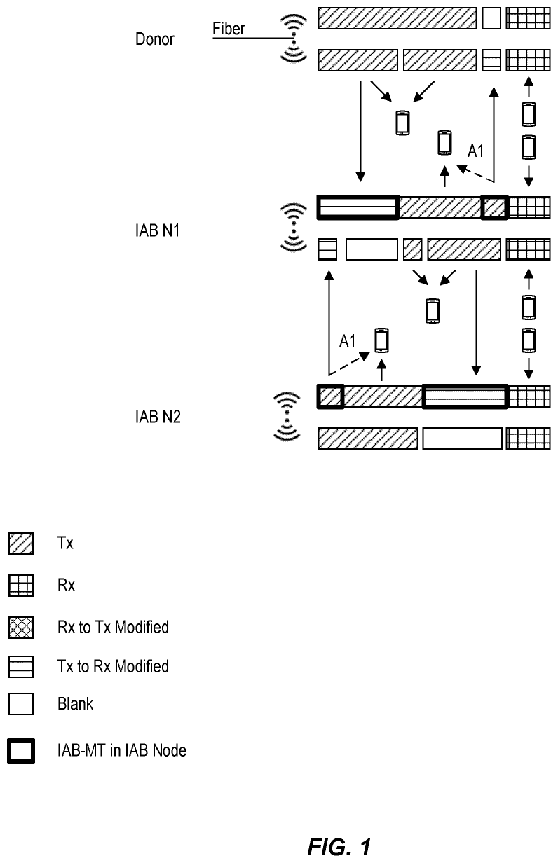

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Note that, in the following description, embodiments in which both an aggressor node (i.e., the source of an interferer) and the victim node (i.e., the node at which the interferer is received/present) are Integrated Access and Backhaul (IAB) nodes. However, the systems and methods described herein can be applied in other types of networks, as will be appreciated by those of ordinary skill in the art upon reading this disclosure. For example, the systems and methods described herein may be applied in future variations of a 3GPP system, which may have more cross-link interference. Examples include variations of a 3GPP system that utilize dynamic Time Division Duplexing (TDD) and/or full duplex operation.

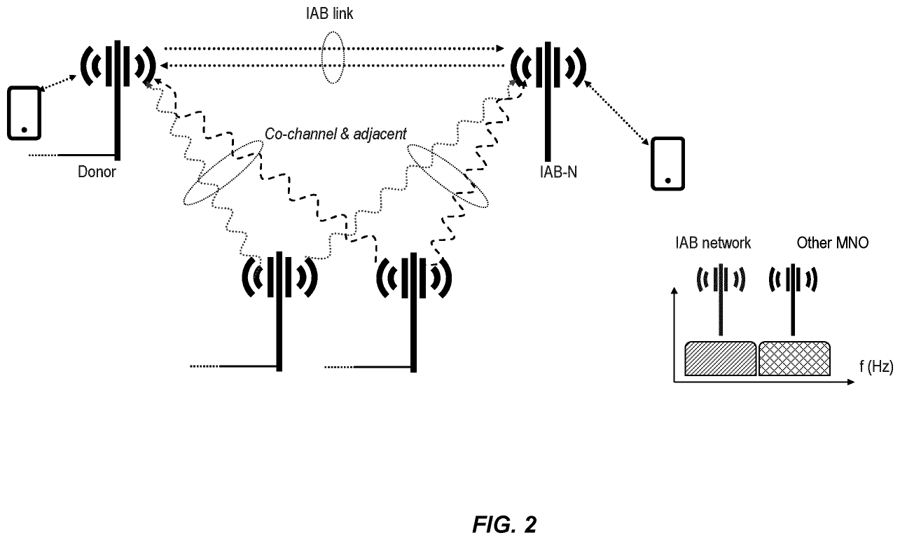

Existing technology, particularly for IAB network architectures and radar operation, suffer from the following problems. One problem with IAB and radar operation in downlink slots of a wireless communication system (e.g., a 5G or 6G wireless communication system) is that all base stations in the system are in transmit mode in the downlink slot and, as such, there is high likelihood of interference sources. In this regard, FIG. 2 shows one common possible scenario in where there is co-channel and/or adjacent channel interference between the backhaul link from one IAB node to a IAB donor node and the backhaul link from another IAB node and an Nth IAB node (denoted as “IAB-N”). Note that FIG. 2 is not to scale, the aggressor node (i.e., the source of the interference) may be very close to the victim node (i.e., the node at which the interference is received). The aggressor node transmits either IAB traffic to another IAB node or UE traffic to a UE (not shown) that resides in between the aggressor node and the victim node. The aggressor node can be either a co-channel interferer or an adjacent channel interferer. This interference could occur intermittently but may always or frequently be in the same direction, e.g., in the case of IAB since the positions of the IAB nodes are normally fixed. Note that the IAB backhaul link normally uses high order modulation for good efficiency, which makes the IAB backhaul link more sensitive to interference.

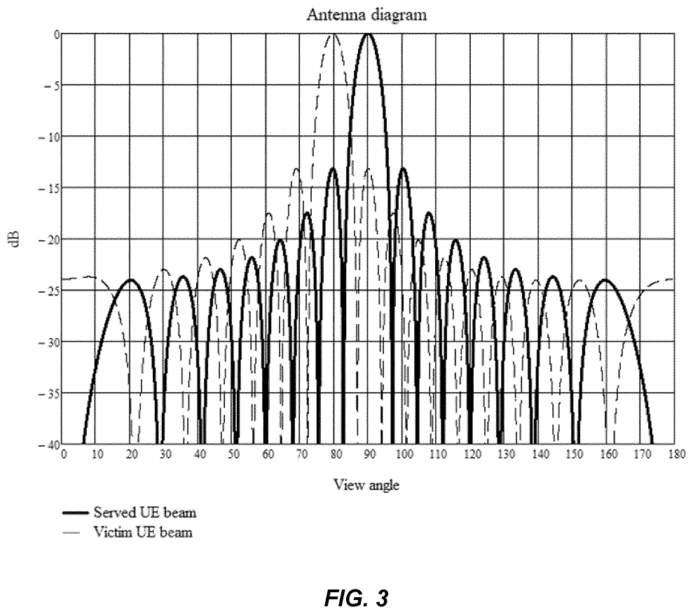

In most cases, the direction of the IAB backhaul link does not coincide with the direction of the aggressor. However, the beam pattern, or beam shape, used by the victim receiver can have strong sidelobes in the direction of the aggressor. For example, FIG. 3 depicts a typical one-dimensional beam pattern when using a uniform linear array. As seen in FIG. 3, the beam pattern has strong side lobes when can cause a strong out-of-beam response. Note that the beam pattern is generally two-dimensional, and FIG. 3 more specifically illustrates a one-dimensional cut of the two-dimensional beam pattern for readability.

Radar operation is similar to IAB, but in this case, the beam direction changes frequently to scan the desired service area.

Systems and methods are disclosed herein that address the aforementioned and/or other problems associated with existing technology. In one embodiment, a network node (e.g., an IAB node or a network node performing a radar scanning procedure) includes a narrowband receiver in addition to a wideband receiver, where the network node uses the narrowband receiver to the detect the direction(s) (e.g., beam angles) of interference. The wideband receiver receives multiple carriers within the bandwidth of the wideband receiver. Each carrier occupies a different narrower bandwidth within the overall wide bandwidth of the wideband receiver. For example, for an IAB node, the wideband receiver of the IAB node receives at least one downlink carrier from an upstream, or parent, IAB node and at least one uplink carrier from UE(s) served by the IAB node. In one embodiment, whenever degraded link quality, or link performance, is experienced for one or more of the carriers received by the wideband receiver, the network node enables the narrowband receiver to detect the direction(s) of the interference in respective portions of the wide frequency band of the wideband receiver. Using the narrowband receiver, the network node is enabled to scan the environment for interference, both in spatial domain and the frequency domain. In one embodiment, multiple measurements may be needed for wideband frequency scanning. In one embodiment, the bandwidth of the narrowband receiver is limited (analog filter, analog bandwidth in downconverter, Analog to Digital Converter (ADC) bandwidth) by the Instantaneous Bandwidth (IBW) for which the narrowband receiver of the network node has been designed. The narrowband receiver IBW will then be limited to the IBW of the total receiver. Outside the IBW, the network node is less sensitive to interferers due to analog selectivity in the receiver.

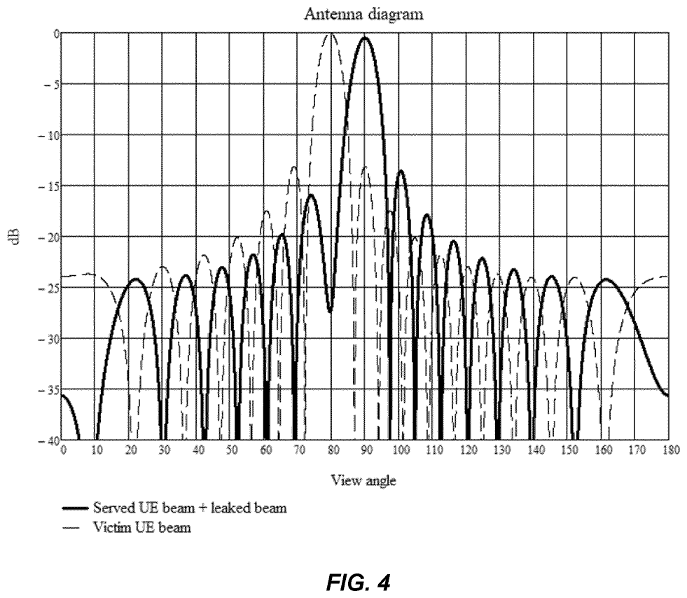

In one embodiment, once the direction(s) of the interference has been detected using the narrowband receiver, the beam shape(s) (i.e., beam pattern(s)) of the receiving beam of the wideband receiver of the network node is (are) modified to form a null(s) in the direction(s) of the interference to thereby mitigate degradation of link performance of the carriers received at the network node via the wideband receiver due to the interference. In this regard, FIG. 3 shows an example of a beam pattern without any extra null, and FIG. 4 shows a modified version of the beam pattern of FIG. 3 after a null has been placed in the beam pattern in the direction of the interference. In this example, as can be seen in FIG. 3, the interferer (represented by the dashed line) is at a direction that corresponds to a beam angle of 80 degrees when the primary, or main, beam lobe of the beam pattern is at 90 degrees. The first sidelobe of the beam pattern is in the direction of the interferer. As can be seen in FIG. 4, in this example, the beam pattern is modified to include a null in the beam pattern (solid line) towards the aggressor, which in this example is in a direction that corresponds to a beam angle of 80. The first sidelobe on left side (solid line) is in same direction as the interferer and is now-27 dB relative main lobe. Thus, 14 dB spatial selectivity is gained in this example.

In other words, systems and method are disclosed herein in which a narrowband receiver of a network node is utilized as a spatial spectrum analyzer for interferer, or blocker, power and direction (e.g., beam angle) detection. In one embodiment, the narrowband receiver is used to measure both on the network node's own spectrum and on adjacent channels (e.g., owned by another operator(s)). In one embodiment, if needed, multiple measurements may be performed using the narrowband receiver with adjusted center frequency to cover a desired or needed frequency range.

In one embodiment, the network node updates one or more beam patterns used by the network node to include a null(s) in the direction of the interferer(s) detected via the narrowband receiver.

In one embodiment, the narrowband receiver is enabled to detect the direction of the interferer(s) when link quality, or performance, degrades to a defined or configured threshold.

In one embodiment, both the network node and the aggressor node(s) are IAB nodes or other network nodes that are static (i.e., do not move) and, as such, there are no stringent timing requirements on the detection of the direction(s) of the interferer(s).

In another embodiment, in a radar application, an interferer, or blocker, will degrade some direction(s) of the radar scanning area. In this case, embodiments are disclosed in which a blocker(s) is mitigated both by changing the beam pattern and introducing a null when measuring close to the blocker direction and by lowering the gain and thus improving linearity when main beam is pointing towards the blocker. On top of this, to avoid causing a lot of interference, a null may be introduced in the radar transmit beam or the power of the radar signal may be reduced.

In another embodiment, in a radar application, a narrowband receiver is used to detect the direction(s) of the interferer(s), or blocker(s), and radar scanning is modified to exclude the direction(s) of the interferer(s). In one embodiment, the detection of the direction of the interferer(s) is performed in parallel with the radar scanning such that the direction(s) excluded from radar scanning are updated over time. In this manner, radar scanning may be performed in the direction of the source(s) of the interferer(s) in time periods during which the source(s) of the interferer(s) are not transmitting.

Embodiments of the present disclosure may provide a number of advantages over existing technology. While not being limited to or by any such advantages, some examples are as follows. Embodiments of the present disclosure may enable more robust IAB/radar operation. Embodiments of the present disclosure may enable simplified cell planning, since it will be easier to place an IAB node closer to other network nodes (e.g., base stations). Embodiments of the present disclosure may avoid or minimize radar blind spots and avoid radar operation polluting other network node (e.g., base station) communication links. Embodiments of the present disclosure may provide support for denser networks.

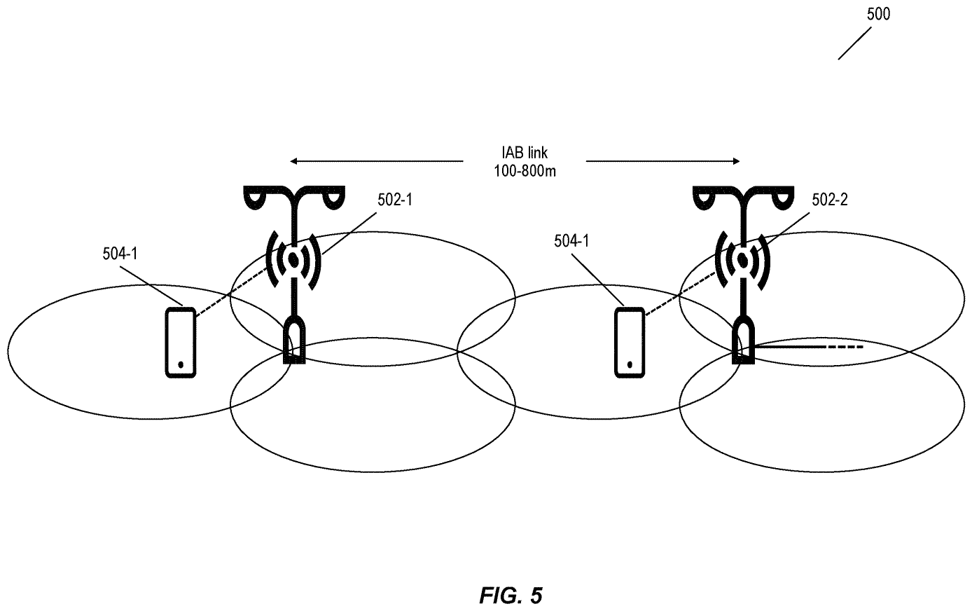

FIG. 5 illustrates one example of a wireless communication system 500 in which embodiments of the present disclosure may be implemented. In this example, the wireless communication system 500 includes IAB nodes 502-1 and 502-2 that provide wireless access links to UEs 504-1 and 504-2, respectively. In addition, backhaul traffic is communicated between the IAB nodes 502-1 and 502-2 via a wireless backhaul link.

In embodiments of the present disclosure, each of the IAB nodes 502-1 and 502-2 is equipped with both a wideband receiver and a narrowband receiver. The wideband receiver is used to receive a wideband signal over wide frequency range that includes multiple carriers (e.g., both a downlink carrier(s) from one or more parent IAB nodes and one or more uplink carriers for cell(s) served by the IAB node 502). The narrowband receiver is used to detect the direction(s) (e.g., beam angle(s)) of interferer(s), as described in detail below. In one embodiment, the IAB nodes 502-1 and 502-2 may then update one or more beam patterns used by the wideband receivers of the IAB nodes 502-1 and 502-2 for beamforming to place a null(s) at the detected direction(s) of the interferer(s). This may be particularly beneficial for the IAB receivers, where the IAB receivers may receive IAB backhaul traffic during downlink slots that are also used for downlink traffic to the UEs 504-1 and 504-2.

Before proceeding with the description of the use of a narrowband receiver for the detection of the direction(s) of interferer(s), a description of one example embodiment of an IAB node equipped with both a wideband receiver and a narrowband receiver is beneficial. Note, however, that this is only any example. Other architectures of the IAB node including a narrowband receiver may alternatively be used.

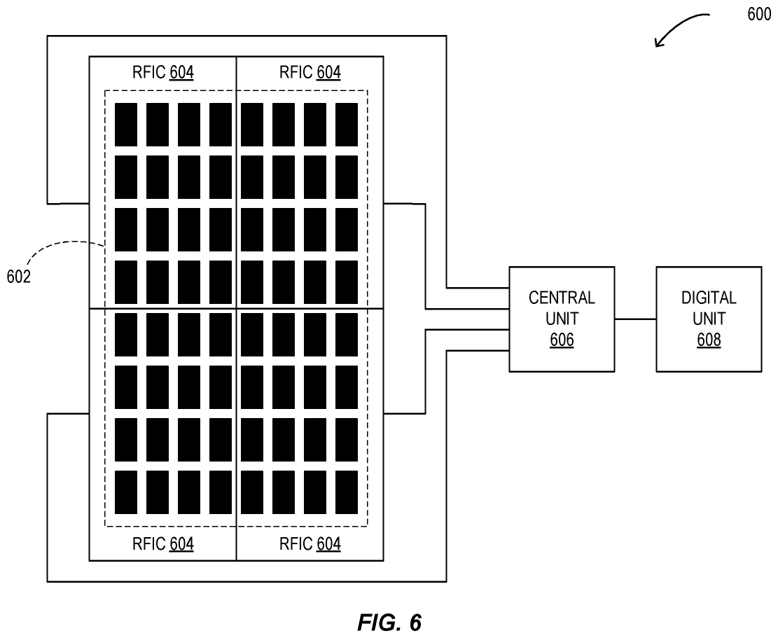

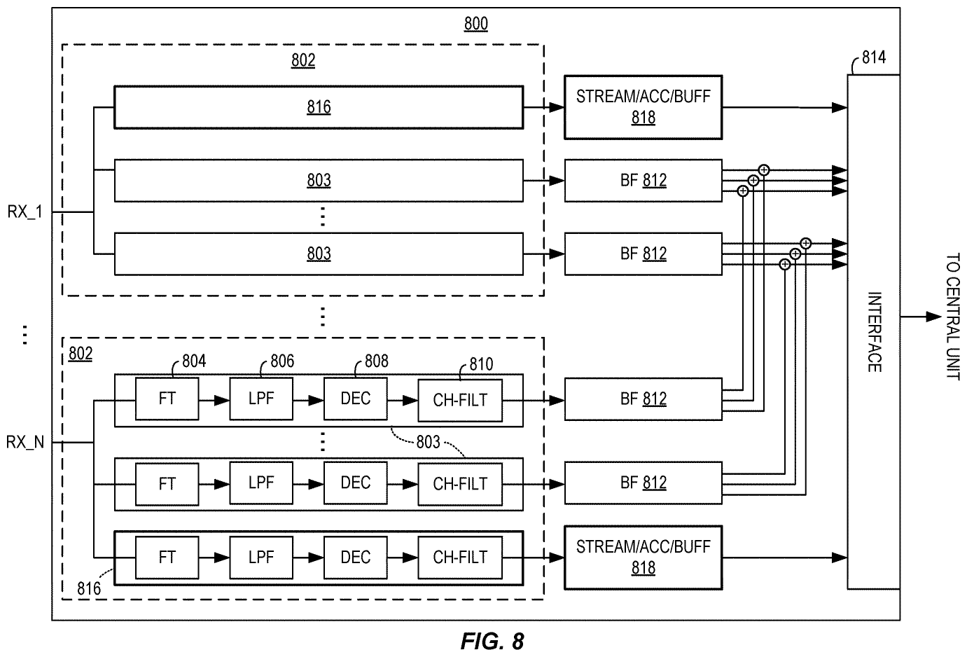

FIG. 6 shows a one example embodiment of an IAB node 600. The IAB node 600 be, e.g., the IAB node 502-1 or the IAB node 502. The IAB node 600 includes an antenna matrix 602 with many antenna elements, where the antenna matrix 602 is divided into portions, each controlled by a respective Radio Frequency Integrated Circuit (RFIC) 604. The RFICs 604 are interconnected to a central unit 606, where the carriers from each RFIC 104 are added and further processed. The central unit 606 combines the signals from all RFICs 604, performs signal processing, and sends the result to a Digital Unit (DU) 608 for further analysis. For example, the central unit 606 combines all the received signals and converts them to frequency domain using a Discrete Fourier transform (DFT). Each RFIC 604 contains an analog portion and a digital portion. Note that the RFICs 604 work together to form a single wideband receiver. Also, note that the narrowband receivers (NBRs) 816 (see FIG. 8; also referred to herein as “NBR blocks” of a single narrowband receiver) across all of the RFICs 604 form a single narrowband receiver.

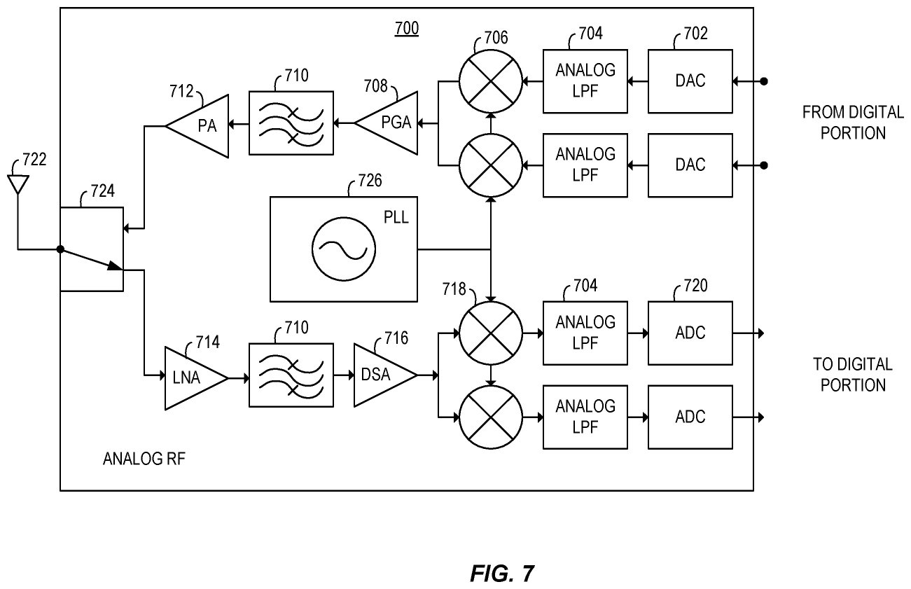

FIG. 7 shows a generic block diagram of an analog RF transceiver 700, which is part of the analog portion of an RFIC 604. A typical RFIC 604 may have one analog RF transceiver 700 per antenna segment serviced by the RFIC 604. The upper part of FIG. 7 shows the transmitter consisting of digital to analog converters (DACs) 702, analog Low-Pass Filters (LPFs) 704, up-conversion mixers 706, programmable gain amplifiers 708, Band-Pass Filters (BPFs) 710, and Power Amplifiers (PAS) 712. The lower part of FIG. 7 shows the receiver, consisting of a low noise amplifier (LNA) 714, BPF 710, Digital Step Attenuator (DSA) 716, down-conversion mixers 718, LPFs 704, and Analog to Digital Converters (ADCs) 720. In the middle of FIG. 7, there is a Phase Locked Loop (PLL) 726, which is used to generate the clock required for up/down conversion mixing. The transmitter and receiver are connected to an antenna 722, e.g., via a duplexer 724.

FIG. 8 shows an example embodiment of a digital portion 800 of an RFIC 604. Each block 802 represents complex (I+Q) signal processing. The digital portion 800 of an RFIC 604 may be coupled to multiple analog RF transceivers 600, each transceiver providing the digital portion 800 with an antenna receive signal, one antenna receive signal per block 802. Within block 802, each antenna receive signal (e.g., RX_1 through RX_N) is split into one or more carriers which are processed via respective carrier processing blocks 803. Each carrier is Frequency Tuned (FT) by FT unit 804 to place the desired carrier at DC. Then each carrier is low-pass filtered by low-pass filter 806, decimated by a decimator 808, and channel filtered by a channel filter 810. Finally, the carriers enter beamforming (BF) units 812 where the carriers are beamformed and combined to form one or several data streams. All data streams from each RFIC 604 are then sent via an interface 814 to the central unit 606 for combination and DFT processing. The number of data streams per carrier is smaller than the number of antennas; in this example three data streams are formed.

FIG. 8 illustrates the complementary digital signal processing needed in the wideband receiver of the IAB node 600. Each antenna signal is filtered, split, and down-converted to individual carriers. Each of the carriers corresponds to a portion of the received spectra. Then the carriers from each antenna are combined to one or several layers in the BF units 812. Each layer is then sent for further processing to a central digital unit. The antenna matrix is normally connected to several RFICs 604, each RFIC 604 handling a number of antenna elements. This system is less complex than full digital BF, in that the number of Fast Fourier Transforms (FFTs) are reduced, i.e., one per layer instead of one per antenna.

In addition, as also illustrated in FIG. 8, the digital portion 800 of the RFIC 604 includes one or more additional blocks that form a narrowband receiver. In particular, in this example, each block 802 includes an additional narrowband receiver (NBR) 816. The NBR 816 filters out narrowband receiver data and sends this narrowband data from each antenna to the CU 606 for further processing. In order to provide access to all antennas by the CU 606, the NBRs 816 are added in the digital domain rather than in the analog domain. Note that each block 802 may include one or more NBRs 816 depending on the particular implementation.

In the embodiment illustrated in FIG. 8, the structure (e.g., the signal processing chain) of the NBR 816 is the same as that of the carrier blocks 803, but the bandwidth of the NBR 816 is less than the bandwidth for the carrier processing blocks 803, and so the carrier processing blocks 803 may be referred to herein as Wideband Receivers (WBRs) 803. In some embodiments, the NBR 816 can capture one full carrier down to some fraction of a full carrier, e.g., one-fourth of a carrier, but other portions are also contemplated by the present disclosure. Also, there is no beamforming of the narrowband receiver paths. Instead, that data is sent to the CU 606 (via the interface 814) for further processing, such as spatial DFT processing to determine beam directions and/or to determine the direction(s) of interferer(s) in accordance with embodiments of the present disclosure.

In the embodiment illustrated in FIG. 8, there is an additional block 818 that can send the data to the CU 606 immediately, e.g., via an interface 814, or buffer it for later sending, but in alternative embodiments that block may be omitted. In some embodiments which include block 818, block 818 can perform accumulation of data. Using this technique, the digital down-conversion and decimation are connected to each antenna, but there is no combining. This achieves narrowband access to each antenna element by the CU 606.

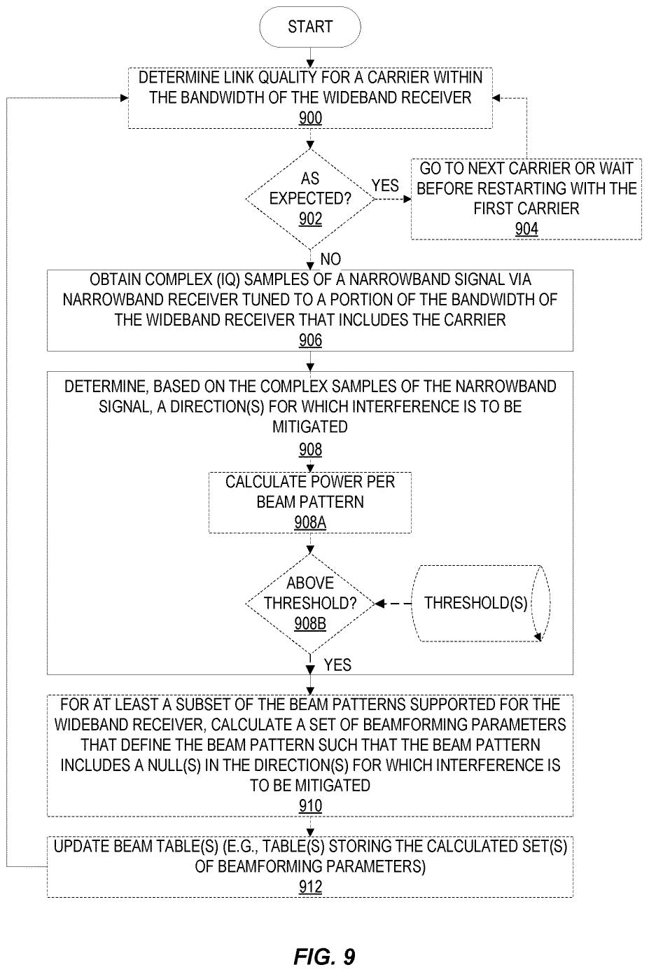

FIG. 9 is a flow chart that illustrates the operation of a network node (e.g., the IAB node 502-1 or 502-2 of FIG. 5 or the IAB node 600 of FIGS. 6-8), in accordance with one embodiment of the present disclosure. Optional steps are represented by dashed lines/boxes. As illustrated, the network node determines a link quality of a carrier within a bandwidth of a wideband receiver of the network node (step 900). As discussed above, the wideband receiver receives a wideband signal over a frequency band that includes multiple carriers. The network node also includes a narrowband receiver having a bandwidth that is, in one embodiment, equal to or greater than a bandwidth of the carrier (or a widest carrier among the multiple carriers received via the wideband receiver). The link quality of the carrier may be determined by determining one or more related parameters such as, e.g., Reference Signal Received Power (RSRP), Reference Signal Received Quality (RSRQ), Signal to Interference plus Noise Ratio (SINR), or the like for the carrier. The network node determines whether the link quality is as expected (e.g., better than a predefined or configured quality threshold) (step 902). If so, the network node proceeds to a next carrier or, if all of the carriers have been checked, waits a predefined or configured amount of time before re-checking the link quality of the carriers (step 904), and the process returns to step 900.

If the link quality of the carrier is not as expected (step 902, NO), the procedure proceeds to step 906. The network node obtains, via the narrowband receiver of the network node, complex (I+Q) samples of a narrowband signal received via the narrowband receiver on a portion of the frequency band of the wideband receiver that includes the carrier (step 906). Note that, here, the “narrowband receiver” as it relates to the example embodiment of the IAB node 600 of FIGS. 6-8 corresponds to the combination of the narrowband receivers 816 for all of the RFICs 604. Thus, the narrowband complex data obtained in step 906 includes data samples from all antenna paths across all of the RFICs 604 and, as such, can be processed in the digital domain (e.g., simultaneously) for all possible beam patterns.

The network node determines, based on the complex samples of the narrowband signal obtained in step 906, one or more directions from which interference is to be mitigated (step 908). More specifically, in one embodiment, the network node processes the complex samples of the narrowband signal to calculate a power value for each of multiple beam patterns having primary, or main, beam lobes that correspond to different beam angles (step 908A). For example, a two-dimensional Discrete Fourier Transform (DFT) is performed to transform the signal into the beam domain and then power is combined (e.g., integrated) per beam, or “bin” of the DFT output, to thereby provide the power value for that beam pattern. Note, however, that this is only an example of how the power for each beam pattern is calculated. Other schemes for calculating the power value for a beam pattern may be used. For each beam pattern for which a power value is calculated, the network node compares the respective power value calculated in step 908A with a respective power threshold (step 908B). Note that the same threshold may be used for all beam patterns or different thresholds may be used for some or all beam patterns for some or all portions of the frequency band. The beam angles of the primary beam lobes of the beam patterns for which the calculated power exceeds the respective threshold are the directions for which interference is to be mitigated.

Note that, in this embodiment, the narrowband receiver has a bandwidth that is equal to or greater than that of the carrier. Thus, the portion of the frequency band for which the narrowband receiver receives the narrowband receiver includes the carrier and, optionally, one or more adjacent channels. However, in another embodiment, the bandwidth of the narrowband receiver is less than the bandwidth of the carrier (e.g., ¼^{th} of the bandwidth of the carrier), in which case steps 906 and 908 may be repeated multiple times to cover the full bandwidth of the carrier and, optionally, one or more adjacent channels.

For each of at least a subset of the beam patterns supported by the network node for the wideband receiver (e.g., at least a subset of the beam patterns for which the wideband receiver is able to be configured), the network node calculates an updated set of beamforming parameters (e.g., beamforming weights) that define the beam pattern such that the beam pattern includes a null(s) at the determined direction(s) for which interference is to be mitigated (step 910). The network node may then store the calculated sets of beam forming parameters by, e.g., updating a respective beam table(s) storing the calculated set(s) of beamforming parameters (step 912). The process may then return to step 900 and be repeated to the next carrier received via the wideband receiver of the network node.

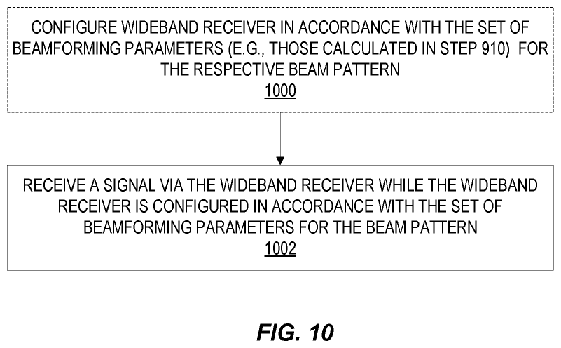

FIG. 10 is a flow chart that illustrates the operation of a network node (e.g., the IAB node 502-1 or 502-2 of FIG. 5 or the IAB node 600 of FIGS. 6-8), in accordance with another embodiment of the present disclosure. As illustrated, the network node configures a wideband receiver of the network node in accordance with a set of beamforming parameters for a desired beam pattern (step 1000). Here, the set of beamforming parameters is a set of beamforming parameters that have been calculated in the process of FIG. 9 to create a null(s) in direction(s) of the interferer(s) using the narrowband receiver. Thus, the process of FIG. 10 is preferably used in association with the process of FIG. 9. The network node then receives a wideband signal via the wideband receiver of the network node while the wideband receiver is configured in accordance with the set of beamforming parameters for the desired beam pattern (step 1002).

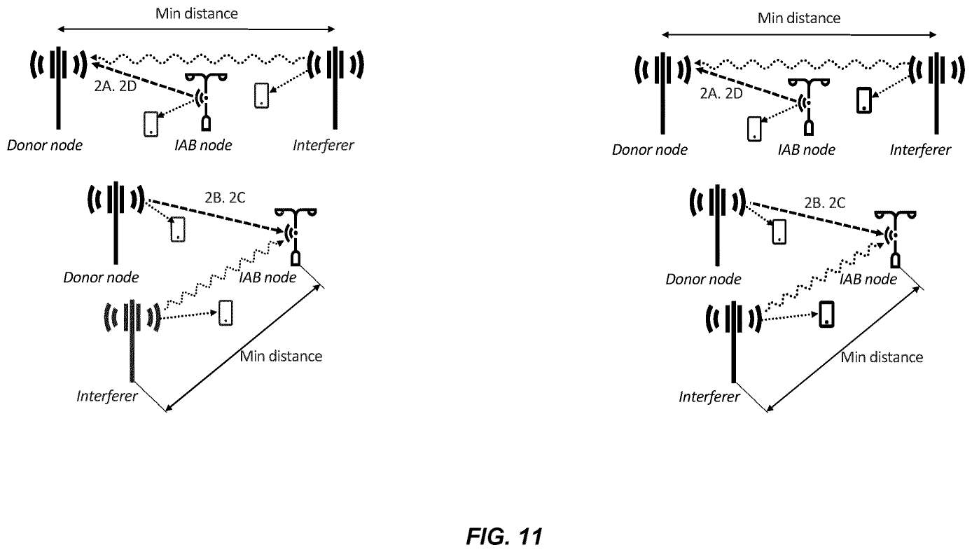

FIG. 11 illustrates one example of a wireless communication system that is enabled to have a more dense deployment for both cell-to-cell distance for the same operator (left side of FIG. 11) as well as more dense deployment between different operators (right side of FIG. 11) by the IAB nodes operating in accordance with embodiments of the present disclosure to mitigate interference.

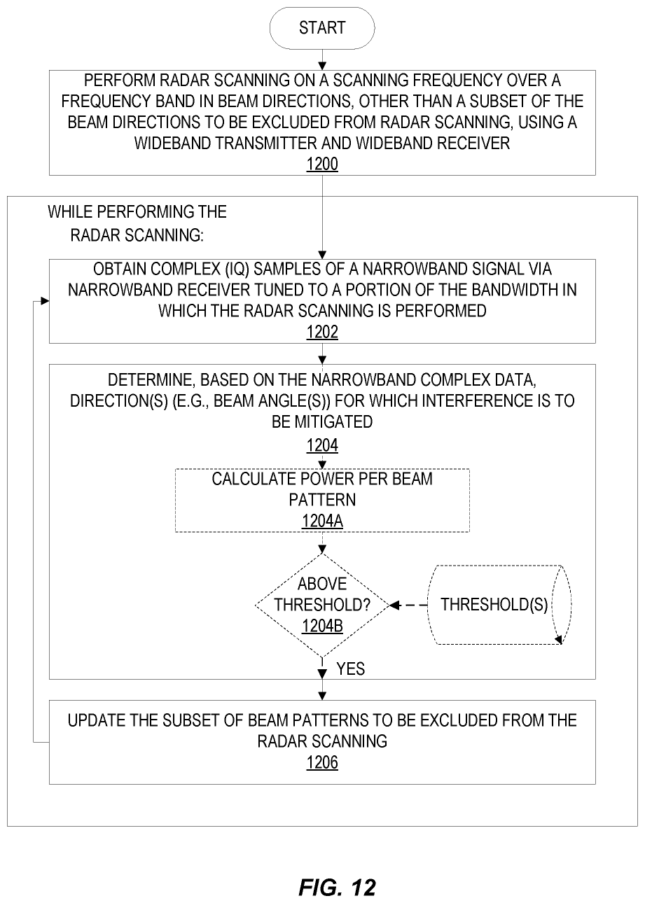

FIG. 12 illustrates the operation of a network node (e.g., an IAB node such as the IAB node 502-1 or 502-2 or the IAB node 600) to utilize a narrowband receiver to detect the direction(s) of interferer(s), or blocker(s), in association with a radar scanning procedure in accordance with another embodiment of the present disclosure.

Optional steps are represented by dashed lines/boxes. As illustrated, the network node performs radar scanning over a frequency band using a wideband receiver and a wideband transmitter a set of beam patterns, where a subset of the set of beam patterns having corresponding primary beam lobes at beam angles identified (e.g., in the process described below) as corresponding to directions to be excluded from the radar scanning are excluded from the radar scanning (step 1200). As described below, the subset of the set of beam patterns to be excluded from radar scanning may change over time as different sets of interferers, or blockers, are detected in steps 1202-1206.

While performing the radar scanning of step 1200 (i.e., in parallel with the radar scanning of step 1200), the network node obtains, via a narrowband receiver of the network node, complex samples of a narrowband signal received via the narrowband receiver tuned to a portion of the frequency band over which the network node performs the radar scanning (step 1202). Based on the obtained complex samples of the narrowband signal obtained in step 1202, the network node determines one or more directions for which interference is to be mitigated or is detected (step 1204). More specifically, in one embodiment, the network node processes the complex samples of the narrowband signal to calculate a power value for each of a set of beam patterns having primary beam lobes at different beam angles (step 1204A). In other words, using the complex samples of the narrowband signal obtained in step 1202, the network node calculates a received power value for each beam pattern from among all or at least a subset of the beam patterns supported by the network node. Each beam patten has a primary beam lobe at a different beam angle. For each beam pattern for which a power value is calculated, the network node compares the respective power value calculated in step 1204A with a respective power threshold (step 1204B). Note that the same threshold may be used for all beam patterns or different thresholds may be used for some or all beam patterns. The beam angles of the primary beam lobes of the beam patterns for which the calculated power exceeds the threshold are the directions for which interference is to be mitigated.

The network node then updates the subset of the beam patterns that are to be excluded from the radar scanning of step 1200 based on the results of step 1204 (step 1206). In one embodiment, the beam pattern(s) having the primary beam lobe(s) that correspond to the directions for which interference is to be mitigated as determined in step 1204 are added to the subset of beam patterns that are to be excluded from the radar scanning of step 1200. In one embodiment, other beam patterns for which interference is not to be mitigated (or is not present) as determined in step 1204 are not included in the subset of beam patterns to be excluded from the radar scanning of step 1200. Thus, over time, the subset of beam patterns excluded from the radar scanning may change. For example, considering a single source of interference that transmits only in some time slots (e.g., only in some downlink time slots), the corresponding beam pattern may be included in the subset of beam patterns to be excluded from the radar scanning during time slots when the source of interference (e.g., another IAB node) is transmitting but not be included in the subset of beam patterns to be excluded from the radar scanning during at least some time slots when the source of interference is not transmitting. Thus, whenever some interference above a predefined threshold is found, the corresponding beam pattern is added to the exception set (i.e., the subset of beam patterns to be excluded from the radar scanning), resulting in this beam pattern not being used for radar scanning. This avoids performing bad quality measurements and in addition avoids causing interference to other links. When interference is removed, the corresponding beam direction is removed from the exception list, possibly with some hysteresis.

Note that, in some embodiments, multiple portions of the frequency band in which the radar scanning is performed are being searched for interference. In this case, steps 1202, 1204, and 1206 are repeated for each of the multiple portions of the frequency band. Further note that, in this case, a beam pattern may be removed from the exclusion list only if the beam pattern is not detected as corresponding to a direction of interference for any of the portions of the frequency band and, optionally, after some predefined or configured amount of time has expired since it was added to the exclusion list.

Also note that, in addition to excluding the subset of the set of beam patterns from the radar scanning in step 1200, the network node may also modify some or all of the remaining beam patterns (i.e., the beam patterns used for beam scanning) such that they include a null(s) in the direction(s) in which interference is to be mitigated in a manner similar to that described above (e.g., in the procedure of FIG. 9).

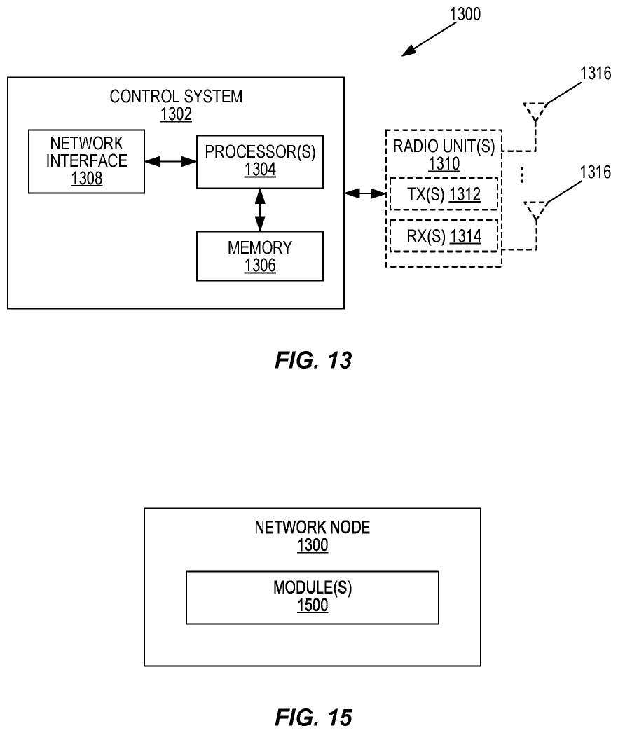

FIG. 13 is a schematic block diagram of a network node 1300 according to some embodiments of the present disclosure. Optional features are represented by dashed boxes. The network node 1300 may be, for example, an IAB node (e.g., the IAB node 502-1 or 502-2 or the IAB node 502) or a base station or a network node that implements all or part of the functionality of the base station. As illustrated, the network node 1300 includes a control system 1302 that includes one or more processors 1304 (e.g., Central Processing Units (CPUs), Application Specific Integrated Circuits (ASICs), Field Programmable Gate Arrays (FPGAs), and/or the like), memory 1306, and a network interface 1308. The one or more processors 1304 are also referred to herein as processing circuitry. In addition, the network node 1300 includes one or more radio units 1310 that each includes transmitters 1312 and receivers 1314 (e.g., a wideband receiver and a narrowband receiver) coupled to one or more antennas 1316. The radio units 1310 may be referred to or be part of radio interface circuitry. In some embodiments, the radio unit(s) 1310 is external to the control system 1302 and connected to the control system 1302 via, e.g., a wired connection (e.g., an optical cable). However, in some other embodiments, the radio unit(s) 1310 and potentially the antenna(s) 1316 are integrated together with the control system 1302. The one or more processors 1304 operate to provide one or more functions of a network node 1300 as described herein. In some embodiments, the function(s) are implemented in software that is stored, e.g., in the memory 1306 and executed by the one or more processors 1304.

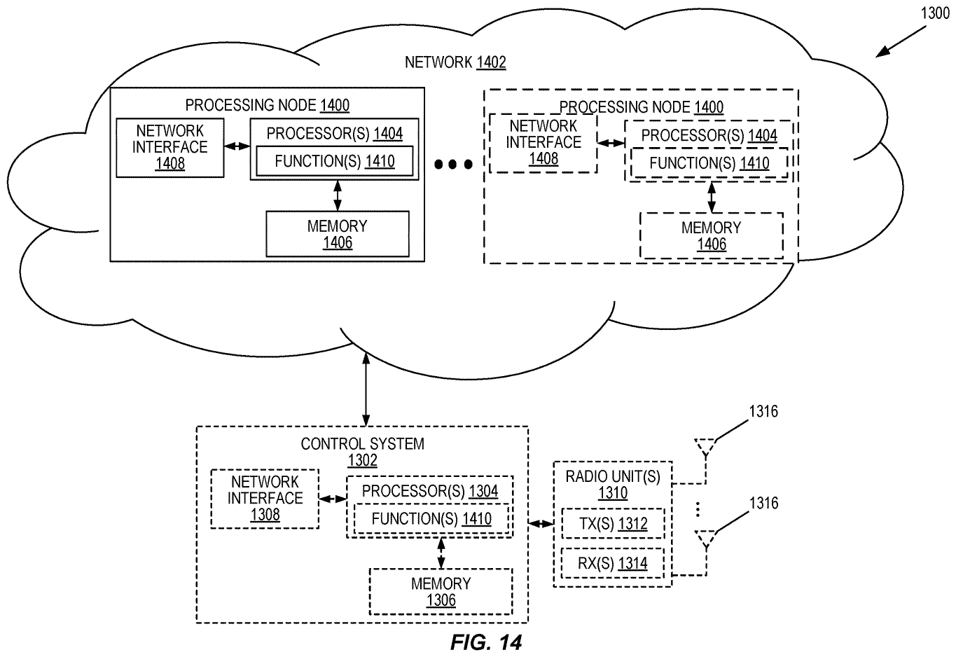

FIG. 14 is a schematic block diagram that illustrates a virtualized embodiment of the network node 1300 according to some embodiments of the present disclosure. This discussion is equally applicable to other types of network nodes. Further, other types of network nodes may have similar virtualized architectures. Again, optional features are represented by dashed boxes.

As used herein, a “virtualized” network node is an implementation of the network node 1300 in which at least a portion of the functionality of the network node 1300 is implemented as a virtual component(s) (e.g., via a virtual machine(s) executing on a physical processing node(s) in a network(s)). As illustrated, in this example, the network node 1300 may include the control system 1302 and/or the one or more radio units 1310, as described above. The control system 1302 may be connected to the radio unit(s) 1310 via, for example, an optical cable or the like. The network node 1300 includes one or more processing nodes 1400 coupled to or included as part of a network(s) 1402. If present, the control system 1302 or the radio unit(s) are connected to the processing node(s) 1400 via the network 1402. Each processing node 1400 includes one or more processors 1404 (e.g., CPUs, ASICs, FPGAs, and/or the like), memory 1406, and a network interface 1408.

In this example, functions 1410 of the network node 1300 described herein are implemented at the one or more processing nodes 1400 or distributed across the one or more processing nodes 1400 and the control system 1302 and/or the radio unit(s) 1310 in any desired manner. In some particular embodiments, some or all of the functions 1410 of the network node 1300 described herein are implemented as virtual components executed by one or more virtual machines implemented in a virtual environment(s) hosted by the processing node(s) 1400. As will be appreciated by one of ordinary skill in the art, additional signaling or communication between the processing node(s) 1400 and the control system 1302 is used in order to carry out at least some of the desired functions 1410. Notably, in some embodiments, the control system 1302 may not be included, in which case the radio unit(s) 1310 communicate directly with the processing node(s) 1400 via an appropriate network interface(s).

In some embodiments, a computer program including instructions which, when executed by at least one processor, causes the at least one processor to carry out the functionality of network node 1300 or a node (e.g., a processing node 1400) implementing one or more of the functions 1410 of the network node 1300 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 15 is a schematic block diagram of the network node 1300 according to some other embodiments of the present disclosure. The network node 1300 includes one or more modules 1500, each of which is implemented in software. The module(s) 1500 provide the functionality of the network node 1300 described herein. This discussion is equally applicable to the processing node 1400 of FIG. 14 where the modules 1500 may be implemented at one of the processing nodes 1400 or distributed across multiple processing nodes 1400 and/or distributed across the processing node(s) 1400 and the control system 1302.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A method performed by network node in a Radio Access Network (RAN) of a wireless communication system, the method comprising:
determining that a link quality for at least one carrier of a plurality of carriers within a bandwidth of a wideband receiver of the network node is less than a predefined or configured link quality threshold;
for each carrier of the at least one carrier for which the link quality is less than the predefined or configured link quality threshold:
obtaining complex data samples of a received narrowband signal received via a narrowband receiver of the network node that is tuned to a portion of the frequency band used by the wideband receiver that comprises the carrier for which the link quality is less than the predefined or configured link quality threshold; and
determining, based on the complex data samples of the narrowband signal, one or more directions from which interference is to be mitigated; and
receiving a wideband signal using a beam pattern which comprises one or more nulls at the directions from which interference is to be mitigated.

2. The method of claim 1, wherein a bandwidth for the narrowband receiver is such that the portion of the frequency band used by the wideband receiver for which the complex data samples of the received narrowband signal are obtained comprises the carrier for which the link quality is less than the predefined or configured link quality threshold and one or more adjacent channels.

3. The method of claim 1, further comprising:
for a beam pattern for which the wideband receiver is able to be configured, calculating a set of beamforming parameters that define the beam pattern such that the beam pattern comprises one or more nulls at the directions from which interference is to be mitigated;
wherein receiving the wideband signal comprises receiving the wideband signal while the wideband receiver is configured in accordance with the set of beamforming parameters for the beam pattern.

4. The method of claim 1, wherein determining the one or more directions from which interference is to be mitigated comprises:
calculating, based on the complex data samples obtained via the narrowband receiver, a plurality of received power values for a respective plurality of beam patterns having corresponding primary beam lobes at different beam angles; and
determining, based on the plurality of received power values, one or more beam patterns from among the plurality of beam patterns for which the received power values are greater than a predefined or configured threshold;
wherein the one or more directions from which interference is to be mitigated are directions that correspond to the beam angles of the primary beam lobes of the one or more beam patterns for which the receiver power values are greater than the predefined or configured threshold.

5. The method of claim 1, wherein the at least one carrier for which the link quality is less than the predefined link quality threshold consists of a single carrier.

6. The method of claim 1, wherein the at least one carrier for which the link quality is less than the predefined link quality threshold consists of two or more carriers.

7. The method of claim 1, wherein the network node is an Integrated Access and Backhaul (IAB) node.

8. (canceled)

9. A network node for a Radio Access Network (RAN) of a wireless communication system, comprising processing circuitry configured to cause the network node to:
determine that a link quality for at least one carrier of a plurality of carriers within a bandwidth of a wideband receiver of the network node is less than a predefined or configured link quality threshold;
for each carrier of the at least one carrier for which the link quality is less than the predefined or configured link quality threshold:
obtain complex data samples of a received narrowband signal received via a narrowband receiver of the network node that is tuned to a portion of the frequency band used by the wideband receiver that comprises the carrier for which the link quality is less than the predefined or configured link quality threshold; and
determine, based on the complex data samples of the narrowband signal, one or more directions from which interference is to be mitigated; and
receive a wideband signal using a beam pattern which comprises one or more nulls at the directions from which interference is to be mitigated.

10. The network node of claim 9, wherein a bandwidth for the narrowband receiver is such that the portion of the frequency band used by the wideband receiver for which the complex data samples of the received narrowband signal are obtained comprises the carrier for which the link quality is less than the predefined or configured link quality threshold and one or more adjacent channels.

11. The network node of claim 9, wherein the processing circuitry is further configured to cause the network node to:
for a beam pattern for which the wideband receiver is able to be configured, calculate a set of beamforming parameters that define the beam pattern such that the beam pattern comprises one or more nulls at the directions from which interference is to be mitigated; and
receive the wideband signal while the wideband receiver is configured in accordance with the set of beamforming parameters for the beam pattern.

12. The network node of claim 9, wherein, in order to determine the one or more directions from which interference is to be mitigated, the processing circuitry is further configured to cause the network node to:
calculate, based on the complex data samples obtained via the narrowband receiver, a plurality of received power values for a respective plurality of beam patterns having corresponding primary beam lobes at different beam angles; and
determine, based on the plurality of received power values, one or more beam patterns from among the plurality of beam patterns for which the received power values are greater than a predefined or configured threshold;
wherein the one or more directions from which interference is to be mitigated are directions that correspond to the beam angles of the primary beam lobes of the one or more beam patterns for which the receiver power values are greater than the predefined or configured threshold.

13. A method performed by a network node in a Radio Access Network (RAN) of a wireless communication system, the method comprising:
performing radar scanning over a frequency band using a plurality of beam patterns having corresponding primary beam lobes at different beam angles, other than a subset of the plurality of beam patterns to be excluded from radar scanning, using a wideband transmitter and a wideband receiver of the network node;
obtaining complex samples of a narrowband signal received via a narrowband receiver of the network node that is tuned to a portion of the frequency band over which the network node performs the radar scanning;
determining, based on the complex samples of the narrowband signal, one or more directions for which interference is to be mitigated; and
updating (1206) the subset of the plurality of beam patterns to be excluded from radar scanning based on the determined one or more directions for which interference is to be mitigated.

14. The method of claim 13, wherein the steps of obtaining, determining, and updating are performed while performing the radar scanning.

15. The method of claim 13, wherein determining the one or more directions for which interference is to be mitigated comprises:
calculating, based on the complex samples of the narrowband signal, a plurality of received power values for the plurality of beam patterns, respectively, wherein the plurality of beam patterns have primary beam lobes at different beam angles; and
determining, based on the plurality of received power values, one or more beam patterns having primary beam lobes at beam angles that correspond to the one or more directions for which interference is to be mitigated.

16. The method of claim 15, wherein determining, based on the plurality of received power values, the one or more beam patterns having primary beam lobes at beam angles that correspond to the one or more directions for which interference is to be mitigated comprises:
for each received power value:
comparing the received power value to a respective power threshold;
wherein the respective beam pattern is determined to be one of the one or more beam patterns having primary beam lobes at beam angles that correspond to the one or more directions for which interference is to be mitigated if the received power value is greater than the respective power threshold.

17. The method of claim 13, further comprising repeating the steps of obtaining, determining, and updating for one or more additional portions of the frequency band over which the network node performs the radar scanning.

18. The method of claim 13, wherein the network node is an Integrated Access and Backhaul (IAB) node.

19. (canceled)

20. A network node for a Radio Access Network (RAN) of a wireless communication system, the network node comprising processing circuitry configured to cause the network node to:
perform radar scanning over a frequency band using a plurality of beam patterns having corresponding primary beam lobes at different beam angles, other than a subset of the plurality of beam patterns to be excluded from radar scanning, using a wideband transmitter and a wideband receiver of the network node;
obtain complex samples of a narrowband signal received via a narrowband receiver of the network node that is tuned to a portion of the frequency band over which the network node performs the radar scanning;
determine, based on the complex samples of the narrowband signal, one or more directions for which interference is to be mitigated; and
update the subset of the plurality of beam patterns to be excluded from radar scanning based on the determined one or more directions for which interference is to be mitigated.

21. The method of claim 20, wherein, in order to determine the one or more directions for which interference is to be mitigated, the processing circuitry is further configured to cause the network node to:
calculate, based on the complex samples of the narrowband signal, a plurality of received power values for the plurality of beam patterns, respectively, wherein the plurality of beam patterns have primary beam lobes at different beam angles; and
determine, based on the plurality of received power values, one or more beam patterns having primary beam lobes at beam angles that correspond to the one or more directions for which interference is to be mitigated.
